(19) United States
(12) Patent Application Publication
(10) Pub. No.: US 2013/0063946 A1
(43) Pub. Date: Mar. 14, 2013

(54) LIGHTING APPARATUS

(71) Applicant: Thomas Preuschl, Sinzing (DE)

(72) Inventor: Thomas Preuschl, Sinzing (DE)

(73) Assignee: OSRAM AG, Muenchen (DE)

(21) Appl. No.: 13/699,306

(22) PCT Filed: May 13, 2011
(86) PCT No.: PCT/EP2011/057737

§ 371 Date: Nov. 21, 2012

(30) Foreign Application Priority Data
May 21, 2010 (DE) 10 2010 029 227.3

(51) Int. Cl. F21V 21/00

(52) U.S. Cl. 362/249.02; 29/592.1

(57) ABSTRACT

A lighting apparatus may include: a light source substrate, to the front side of which at least one semiconductor light source is fitted and the rear side of which is fitted to an electrically conductive carrier; wherein alongside the light source substrate at least two electrically conductive contact pins are led through the carrier and the contact pins are electrically connected to the at least one semiconductor light source; wherein the contact pins are in each case introduced into an electrically insulating sleeve and the respective sleeve is inserted into an associated cutout of the carrier.

The invention relates to a lighting apparatus, more particularly a luminous module, more particularly an LED module, including a light source substrate, to the front side of which at least one semiconductor light source, more particularly light-emitting diode, is fitted and the rear side of which is fitted to an electrically conductive carrier.

The prior art has not succeeded in enabling LED modules as shared components or in the context of a shared-component concept.

The object of the present invention is at least partly to eliminate the disadvantages of the prior art and, in particular, to provide a particularly universally usable lighting apparatus, more particularly an LED module.

This object is achieved in accordance with the features of the independent claims. Preferred embodiments can be gathered, in particular, from the dependent claims.

The object is achieved by means of a lighting apparatus, including a light source substrate, to the front side of which at least one semiconductor light source, more particularly light-emitting diode, is fitted and the rear side of which is fitted to an electrically conductive carrier, wherein alongside the light source substrate at least two electrically conductive contact pins are led through the carrier and the contact pins are electrically connected to the at least one semiconductor light source, wherein the contact pins are in each case introduced into an electrically insulating sleeve and the respective sleeve is inserted into an associated cutout of the carrier.

By means of the contact pins, the lighting apparatus can be mechanically and electrically contact-connected in a simple manner from a (rear) side facing away from the light source substrate, in order to introduce a supply voltage. The contact pins can be arranged with a great design variability. Moreover, for a uniform, e.g. standardized, contact-connection of the lighting apparatus, the advantage is afforded that the arrangement of the contact pins is highly decoupled from an arrangement and configuration of the light source substrate. Thus, many different light source substrates (with the associated semiconductor light sources) can be connected to the same and identically arranged contact pins. This enables a universal usability even of very differently shaped lighting apparatuses. Consequently, it is possible to dispense with plugs laterally or in a light-emitting region of the lighting apparatus, which saves structural space and, in particular, enables a small structural height. A small structural space likewise supports standardizibility.

The associated contact pin advantageously runs through the center of the sleeve. The sleeve is preferably configured as cylindrical or ring-shaped for a laterally uniform material property and electrical property. The contact pin is, inter alia, for inexpensive production, preferably a metallic contact pin, e.g. composed of high-grade steel, which can be, in particular, copper-plated or tin-plated.

A very good thermal conductivity is achieved by the electrically conductive carrier, such that waste heat generated by the at least one semiconductor light source can effectively flow through the light source substrate to the carrier and be dissipated from there. Consequently, the carrier can also serve as a heat sink. In order to intensify the heat dissipation, the carrier can have, in particular at its front side and/or at its lateral edge, at least one structuring, e.g. at least one cooling projection such as at least one cooling pin, at least one cooling rib, etc.

The electrically insulating sleeves serve to maintain creepage paths and to be able to make contact with the lighting apparatus from the rear. The diameter of the sleeve can be chosen depending on the desired lighting apparatus, e.g. the length of the required creepage paths.

The contact pins can be electrically connected to the at least one semiconductor light source in various ways. It is advantageous for a particularly simple electrical connection over variable distances if said connection is implemented by means of a wire connection or by means of wire bonding. The contact pins are preferably indirectly connected to the at least one semiconductor light source, namely via the light source substrate. Thus, a contact pin can be connected to a contact zone of the light source substrate, which is in turn electrically connected to the semiconductor light source, if appropriate via an interposed logic (electronic unit), such as a driver. The logic or electronic unit is then preferably arranged on the light source substrate.

The number and property of the at least one semiconductor light source are not restricted. Preferably, the at least one semiconductor light source includes at least one light-emitting diode. If a plurality of light-emitting diodes are present, they can emit light in the same color or in different colors. A color can be monochromatic (e.g. red, green, blue, etc.) or multichromatic (e.g. white). The light emitted by the at least one light-emitting diode can also be an infrared light (IR LED) or an ultraviolet light (UV LED). A plurality of light-emitting diodes can generate a mixed light; e.g. a white mixed light. The at least one light-emitting diode can contain at least one wavelength-converting phosphor (conversion LED). The at least one light-emitting diode can be present in the form of at least one individually housed light-emitting diode or in the form of at least one LED chip. A plurality of LED chips can be mounted on a common substrate (“submount”). The light source carrier can be the submount. The at least one light-emitting diode can be equipped with at least one dedicated and/or common optical unit for beam guiding, e.g. at least one Fresnel lens, collimator, and so on. Instead of or in addition to inorganic light-emitting diodes, e.g. based on InGaN or AlInGaP, organic LEDs (OLEDs, e.g. polymer OLEDs) can generally be used as well. Alternatively, the at least one semiconductor light source can include e.g. at least one diode laser.

In one configuration, the sleeves consist of glass. Glass has a very good electrical insulation, can be produced industrially in a simple manner and enables a tight enclosure of the contact pins in a simple manner. In particular, the enclosure can be embodied in gas-tight fashion.

During production, the glass sleeves are preferably melted on to the contact pins before the latter are introduced into the electrically conductive carrier. Particularly if the glass sleeves are produced from a pulverulent raw material, after being melted on to the contact pins they can be connected to the carrier by a further sintering step. A particularly secure and gas-tight connection between the components is obtained as a result. However, instead of or in addition to the sintering process, still other thermal processes for fixing the glass sleeve are also conceivable, for example shrink fitting or soldering-in.

However, other electrically insulating materials can also be used, such as plastic or ceramic.

In another configuration, the rear side of the light source substrate is connected to the carrier by means of a thermally conductive adhesive. This improves heat dissipation from the semiconductor light sources.

In yet another configuration, the contact pins are led through the carrier adjacent to a same side of the light source substrate.

In another configuration, the lighting apparatus includes an at least partly electrically conductive cover, which is seated on the carrier and curves over the sleeves and the light source substrate, and wherein the cover has a light-transmissive insert above the at least one light source. The cover serves to afford protection against touching the current-carrying parts of the connected lighting apparatus, in particular a logic/electronic unit. Moreover, the lighting apparatus can thus be configured as light-tight, dust-tight, water-tight and/or gas-tight and, consequently, is suitable e.g. for outdoor applications and special applications. There is no need for cost-intensive protective coatings on the substrate. Moreover, this results in better EMC protection, and a better thermal behavior on account of an enlarged heat emitting area. The cover can also be present as a fully metallic cover body into which the light-transmissive insert is inserted. The fully metallic cover body is simple to produce and enables particularly good heat dissipation and particularly effective EMC protection.

In another configuration, the light-transmissive insert is mounted on the cover by means of a bearing step. As a result, the light-transmissive insert can be mounted in a simple manner and positioned precisely.

In another configuration, the light-transmissive insert is fixed (permanently) to the cover by means of an adhesive connection or an adhesive. As a result, the light-transmissive insert can be mounted securely, tightly and without an increase in the structural height. Particularly in conjunction with the bearing step, a defined and spatially precisely delimited introduction of an adhesive is made possible.

The adhesive can be, for example, an adhesive dispensing arrangement.

In one development, the light-transmissive insert is configured as disc-shaped or plate-shaped, which supports a small structural height and simple production. The light-transmissive insert can be e.g. circular.

In another development, the light-transmissive insert is an optical element or has an optical function. Thus, the light-transmissive insert can be configured e.g. as a diffuser or as a beam-guiding element (such as a lens or the like).

Furthermore, in one development, the light-transmissive insert is coated, e.g. with a scratch-resistant layer and/or an IR-reflecting layer on an outer side.

The light-transmissive insert can consist, for example, of glass, plastic and/or a ceramic.

Moreover, in one configuration, the cover has at least one lateral mounting recess and/or at least one lateral cutout. The mounting recess has the advantage that a tightness of the cover is maintained. Generally, this configuration affords the advantage that the cover can thus be mounted or positioned and/or demounted in a particularly simple manner, in particular also automatically.

In another configuration, the cover has a substantially ring-shaped supporting element, which supports the cover on the light source substrate, wherein the supporting element surrounds the at least one semiconductor light source and runs laterally outside the light-transmissive insert. In order to increase a luminous efficiency, the supporting element is configured as light-tight, in particular diffusely reflective or specularly reflective. Moreover, a thermal separation between the at least one semiconductor light source and a logic or electronic unit can be achieved by means of the supporting element, such that, in particular, the logic or electronic unit does not overheat. Furthermore, the supporting element enables a press-on force to be exerted on the cover, e.g. in order to hold the cover on the carrier (e.g. if the cover is not cohesively connected to the carrier), without the cover curving inwardly in an undesired manner. For this purpose, and in order to distribute a press-on force uniformly, the cover can also be embodied in a sufficiently mechanically stiff fashion, e.g. by means of a wall thickness of corresponding magnitude or reinforcing ribs. The cover can be pressed or depressed on to the carrier e.g. by means of at least one spring element and/or a clamp element.

By using the supporting element, it can be advantageous for the light source substrate to have one or more regions which are freed of component equipment and/or conductor track routing and in which the supporting element makes mechanical contact with the light source substrate. It is thus possible to avoid damage to the light source substrate in the region of the contact area. For this purpose, the supporting element, in particular with the conductor track substrate, can have an interrupted cutout line, such that conductor tracks can be led to the at least one semiconductor light source without damage. For this purpose, the supporting element can have at least one cutout on the attachment side.

Moreover, in one development, the cover is welded or adhesively bonded to the carrier. Particularly if the cover body and the carrier consist of metal, preferably the same metal, these two elements can be welded, in particular circumferentially welded, in particular laser-welded, to one another. It is thereby possible to achieve a very high tightness with at the same time very high mechanical resistance toward separation of the two elements. Thus, the lighting apparatus can be embodied particularly robustly and tightly in a precise and simply handleable manner.

Alternatively, the cover can be pressed on to the carrier. In order to increase a tightness, the cover and/or the carrier can have at least one sealing element. The pressing-on or the contact pressure can be implemented e.g. by means of at least one spring and/or a clamp, as a result of which screws can be dispensed with for simple handling, such that, for example, no small parts and no screwdrivers are necessary. Moreover, the carrier thus does not need to be reworked, e.g. for introducing screw holes. This in turn results in a simpler mold and less wear in the case of cast carriers, while no drilling, thread cutting and depillaring are required in the case of extruded heat sinks.

Of course, the cover can alternatively also be screwed to the carrier, e.g. manually or by means of a pneumatic or electric screwdriver.

Furthermore, in one configuration, the light source substrate is a ceramic substrate. The use of an (electrically insulating) ceramic has the advantage that said ceramic normatively counts as a reinforced insulation. On the ceramic substrate, in particular, voltage ranges of up to 250 volts can be implemented without any problems. This affords the advantage of operating the light sources and/or a possibly associated logic for example with a low voltage (e.g. 12 volts to 26 volts, e.g. of 24 volts) through to a high voltage (e.g. between 110 volts and 300 volts, e.g. at 230 volts to 250 V).

As an alternative to a ceramic substrate, however, other substrates can also be used, for example commercially available printed circuit boards such as metal-core circuit boards or simple circuit boards, e.g. including an FR4 base material. The printed circuit board can be stiff or flexible (“flexible board”). A flexible printed circuit board has the advantage that it can be placed in a planar manner even on to a carrier which locally is not flat. The printed circuit board can be single-layered or multilayered, but—for planar mounting on the carrier—is preferably populated only on one side.

The substrate can have integrated components, in particular resistors. These are preferably arranged on the underside of the substrate and, in the case of multilayered substrates, also in the inner layers. As a result, a compact construction is achieved and manufacture is simplified.

If the resistors are arranged on the underside, the resistance can be set to very precise tolerances, e.g. 0.1%, by means of laser adjustment, i.e. by altering the geometry of the resistor by means of a laser beam. Further electronic components can also be embodied as integrated components, thus for example capacitors, coils and integrated circuits.

The substrate can also be provided with so-called multi-chip modules, which can be embodied as independent components, but also as integrated structures.

The substrate can be provided with optical means, in particular with reflectors, on the top side (i.e. the side on which the semiconductor light sources are arranged). The luminous efficiency is increased as a result. In particular, the optical means for this purpose have a reflectance of more than 90%. Preferably, the reflectors can be embodied as a lacquer layer, silver layer or layer filled with particles having a high reflectivity, such as titanium dioxide.

The integrated components can preferably be applied by means of paste printing methods, since the latter enable particularly simple production, but other methods are also known to the person skilled in the art.

As pastes, in particular carbon pastes can be applied to the substrate. Carbon pastes have the advantage of a high thermal conductivity, that is to say can also be used for cooling purposes.

In another configuration, the sleeves are surrounded by a respective seal on a rear side of the carrier. This ensures electrical and mechanical external protection in the connection region. For this purpose, sleeves are preferably surrounded circumferentially by the respective seal, e.g. by an O-ring-type seal.

Moreover, in one configuration, the carrier is present in the form of a plate. This enables a particularly flat design. The plate is preferably a metallic plate, which enables good heat dissipation and high stability. The plate form has the advantage, moreover, that the carrier, and thus the lighting apparatus, can be fixed in a simple manner by means of a clamping connection or spring connection to the component, e.g. a connection base, into which it is plugged by means of the contact pins or is fixed by means of a plug/turn connection. Particularly for a realization of a plug/turn connection, the contact pin can have a head, in particular mushroom-shaped head, at a rear region of the carrier, such that the lighting apparatus can be inserted into a keyhole of the component and held. Said component can be e.g. a heat sink or a connection base.

The base can have e.g. at least one keyhole for fixing the lighting apparatus by means of a plug/turn connection.

In yet another configuration, the lighting apparatus is a luminous module. A luminous module can be distinguished, for example, by the fact that it does not have a dedicated power supply system connection, but rather, for operation, is typically fixed and thus electrically contact-connected to a lighting system or a luminaire. The lighting system or the luminaire is in turn provided for being connected to a power supply system. The luminous module has the advantage that many differently configured luminous modules can be plugged on to the same connection of the lighting system or luminaire and a lighting solution which is modular and standardized in terms of connection and nevertheless flexible in terms of lighting technology is thus made possible. However, the lighting apparatus is not restricted thereto and can also be configured as a lamp or a luminaire.

The invention is described in greater detail schematically in the following figures on the basis of exemplary embodiments. In this case, for the sake of clarity, identical or identically acting elements can be provided with identical reference signs.

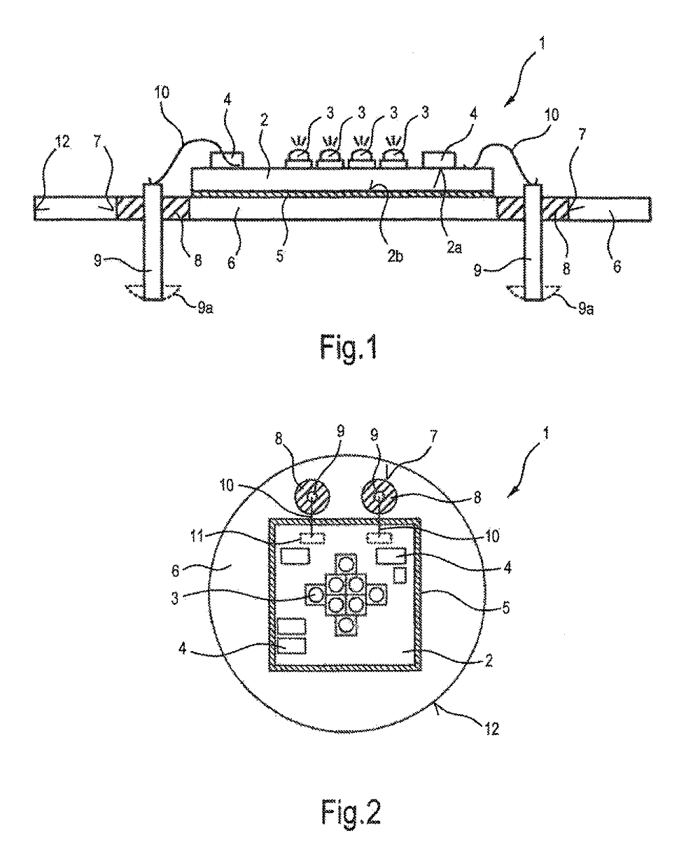

FIG. 1 shows a lighting apparatus in accordance with a first embodiment as a sectional illustration in side view;

FIG. 2 shows the lighting apparatus in accordance with the first embodiment in plan view;

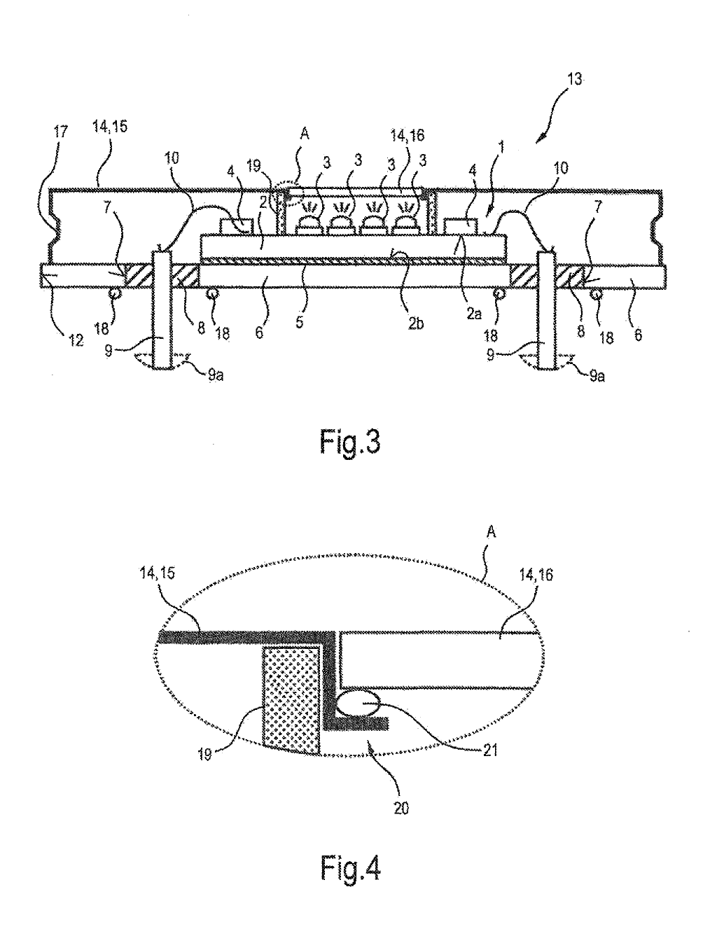

FIG. 3 shows a lighting apparatus in accordance with a second embodiment as a sectional illustration in side view;

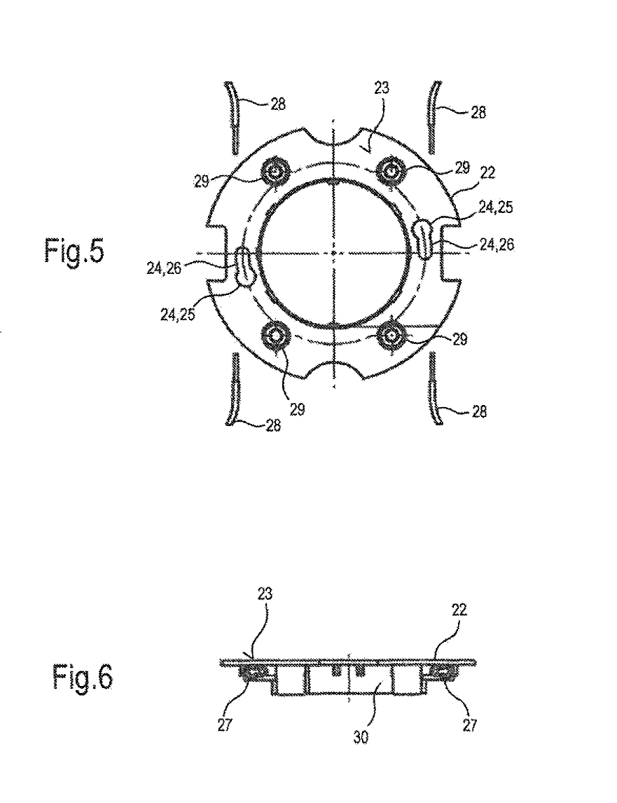

FIG. 4 shows an excerpt from the lighting apparatus in accordance with the second embodiment as a sectional illustration in side view;

FIG. 5 shows a base for receiving a lighting apparatus in plan view;

FIG. 6 shows the base from FIG. 5 in side view; and

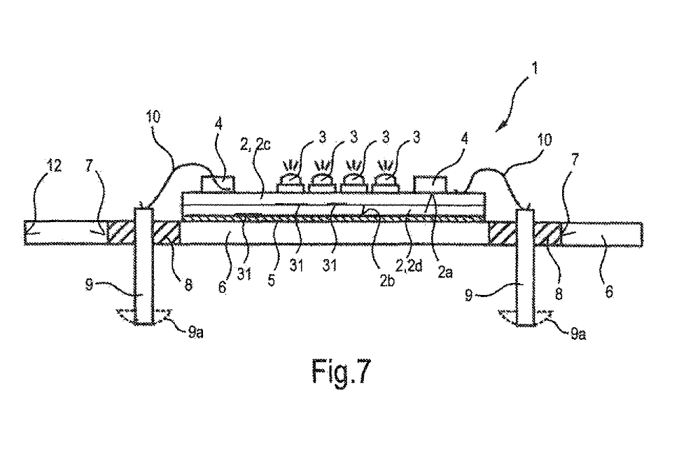

FIG. 7 shows a lighting apparatus in accordance with a third embodiment as a sectional illustration in side view.

FIG. 1 shows a lighting apparatus in the form of an LED module 1. The LED module 1 includes a light source substrate 2, which is embodied as a ceramic substrate and which is equipped with a conductor structure (conductor tracks, contact zones, etc.), at least at its (here upwardly facing) front side 2a (upper figure). At its front side 2a, the light source substrate 2 additionally has a plurality of light-emitting diodes 3 which radiate into an upper or front half-space. The light source substrate 2 is furthermore equipped with a plurality of electronic components 4 (for example logic components, capacitors and resistors, e.g. using surface mounting technology (SMD)) at its front side 2a.

With its (here downwardly directed) rear side 2b, the light source substrate 2 is fitted in a planar manner to a metal plate 6, serving as a carrier, by means of a thermally conductive adhesive 5. The metal plate 6 makes it possible, in a cost-effective manner, for the LED module 1 to be constructed mechanically stably (for example as a result of torsion or other bending being avoided) and thermally advantageously since the metal plate 6 can effectively spread and dissipate waste heat generated by the light-emitting diodes 3.

For making contact with the light source substrate 2 or the light-emitting diodes 3 and the electronic components 4, the metal plate 6 here has two circular cutouts 7, into each of which an electrically insulating sleeve 8 is inserted. An electrically conductive contact pin 9 is in each case guided perpendicularly through the sleeve 8. By means of the two contact pins 9 (however, a different number of contact pins 9 is also possible, e.g. one contact pin 9 or more than two contact pins 9), the LED module 1 can be mechanically fixed and electrically contact-connected at its rear side, to be precise by means of a simple plug movement. Alternatively, the contact pin 9 can have a head 9a (depicted by dashed lines), at its rear end, by means of which head the contact pin can be inserted into a keyhole e.g. of a base and can be turned therein.

At their region adjacent to the light source substrate 2, the contact pins 9 are connected to a respectively associated contact zone 11 (see FIG. 2) by means of a respective electrically conductive wire 10 (“bonding wire”), e.g. composed of copper or a gold-copper alloy. The two contact pins 9 can be connected, for example, to different poles of a voltage source. The contact pins 9 are preferably composed of metal for simple production and good electrical conductivity.

The sleeves 8 in turn consist here of glass (alternatively e.g. of ceramic), thus resulting in a very good electrical insulation of the voltage-carrying contact pins 9 with respect to the metal plate 6 whilst maintaining prescribed creepage paths. Moreover, the sleeves 8 have the advantage that they can be produced simply and with very good sealing.

The LED module 1 has the advantage, inter alia, that the light source substrate 2 with the elements 3, 4 fixed thereto can be configured in a variable fashion, without the metal plate with the sleeves 8 and the contact pins 9 needing to be adapted thereto from the standpoint of technical configuration. As a result, a high design diversity of LED modules 1 can be combined with a standardized bearing area and electrical and mechanical contact-connection.

FIG. 2 shows the LED module 1 in plan view. In this case, the light source substrate 2 is of substantially square shape, but can alternatively also have other shapes, e.g. rectangular or round. By contrast, the metal plate 6 is embodied in circular or round fashion, but can also have any other shapes, e.g. an n (n≧4)-gonal shape or a freeform shape. The contact pins 9 and associated sleeves 8 are arranged here on a common straight side of the light source substrate 2 in the vicinity of a side edge 12 of the metal plate 6, such that a large area is available for positioning the light source substrate 2.

FIG. 3 shows, as a sectional illustration in side view, an LED module 13 in accordance with a second embodiment, which uses the LED module 1 and provides additional elements. In detail, the LED module 13 now additionally has a cover 14 including a metallic basic body 15 and a light-transmissive insert in the form of a glass plate 16. The cover 14 is placed circumferentially on to the metal plate 6 and curves over the sleeves 8 and contact pins 9 and also the light source substrate 2. The cover 14 thus makes it possible to protect the current-carrying parts at the front side of the LED module 13 and makes it possible to confer an IP protection class.

The cover 14 can be pressed on to the metal plate 6 or pressed against the latter, for example by means of at least one spring element (not illustrated). Alternatively, the cover 14 can be welded to the metal plate 6, particularly if the metallic basic body 15 consists of the same metal as the metal plate 6 or these two elements 6, 14 have a material combination suitable for welding. Alternatively, the cover 14 can also be adhesively bonded, screwed or latched to the metal plate 6.

At its lateral edge, the cover 14 or the metal basic body 15 has a recess 17, by means of which the cover 14 can be securely gripped for mounting and/or demounting. The recess 17 can also be designated as a groove. Two sealing rings 18 each assigned to a glass sleeve 8 are situated at the rear side of the metal plate 6, said sealing rings serving for sealing the contact pins 9 in the emplaced state of the LED module 13, e.g. with respect to dust or moisture.

The LED module 13 furthermore includes a ring-shaped, light-opaque supporting element 19, which is seated on the light source substrate 2 and serves as a support with respect to the cover 14. For this purpose, the supporting element 19 (“non-transparent ring”) is dimensioned such that its diameter is greater than the diameter of the glass plate 16 in order that the supporting element 19 does not raise the glass plate 16. The supporting element 19 increases the luminous efficiency since it prevents light from being incident in the space formed by the metallic basic body 15. A luminous efficiency can be increased even further by an inner side—facing the light-emitting diodes 3—of the supporting element 19 being embodied as reflective. The supporting element 19 furthermore prevents the cover 14 from bending inward (that is to say in the direction of the metal plate 6 and the light-emitting diodes 3) when a pressure is applied to its top side or, if appropriate, even owing to the influence of gravity. This can be expedient, in particular, if the cover 14 is pressed on to the metal plate 6 by at least one press-on element (spring and/or clamp, etc.). The supporting element 19 furthermore prevents a free heat exchange of the air heated by the light-emitting diodes 3, such that the electronic components 4 are thermally better protected against waste heat generated by the light-emitting diodes 3.

FIG. 4 shows an excerpt A indicated in FIG. 3 in an enlarged illustration. The excerpt A shows the LED module 13 in the region of the cover 14 in the transition from the metallic basic body 15 to the glass plate 16. The metallic basic body 15, at its central cutout, into which the glass plate 16 is inserted, has marginally a bearing step 20, on to which the glass plate 16 can be placed. The bearing step 20 is formed in the direction of the printed circuit board substrate 2, such that the glass plate 16 can be mounted with regard to its top side substantially areally flush with the metallic basic body 15. An adhesive 21 is used for permanently fixing the glass plate 16 to the metallic basic body 15. The bearing step 20 simultaneously serves as a lateral stop or as a positioning aid for the supporting element 19. Therefore, the internal diameter of the supporting element 19 is preferably made somewhat larger (with a small play) than a diameter of the bearing step 20, which is likewise embodied in a ring-shaped fashion here. Generally, the basic form of the glass plate 16 is not restricted and so the glass plate 16, apart from the basic form in the shape of a circular disc, can also have some other basic form, e.g. an angular basic form.

FIG. 5 shows in plan view a base 22 for receiving a lighting apparatus, e.g. 1 or 13, by placement on to a bearing area 23. FIG. 6 shows the base 22 in side view. The lighting apparatus 1 can be placed on to the bearing area 23 by the rear side of the metal plate 6, wherein the contact pins 9 are firstly inserted into a hole region 25 of a keyhole 24 and are then displaced by a turning movement of the lighting apparatus 1 into a web region 26 of the keyhole 24. The widened head 9a holds the lighting apparatus 1 on the base 22. At the rear of the bearing area 23 (or bearing plate), the keyhole 24 is electrically and mechanically connected in each case to a contact socket 27 having lateral contact-making holes for making contact with electrical connection lines 28. The base 22 can be mounted e.g. by means of a plurality of screw holes 29. At the rear of the bearing area 23, a housing 30 is present, which projects further backward than the contact sockets 27 and enhances the base e.g. for wall or ceiling mounting. The keyhole connection shown in FIG. 5 and FIG. 6 can also be designated as a GU connection or embodied as such.

FIG. 7 shows a lighting apparatus in the form of an LED module 1 corresponding, in principle, to the module 1 shown in FIG. 1. In contrast to the module 1 shown in FIG. 1, in this exemplary embodiment the light source substrate 2 is embodied in a multilayered fashion and integrated components 31 are arranged both on the underside 2b of the light source substrate 2 and between the individual layers 2c, 2d.

It goes without saying that the present invention is not restricted to the exemplary embodiments shown and arbitrary combinations of the exemplary embodiments are conceivable.

### LIST OF REFERENCE SYMBOLS

1 LED module
2 Light source substrate
2a Front side of the light source substrate
2b Rear side of the light source substrate
3 Light-emitting diode
4 Electronic component
5 Thermally conductive adhesive
6 Metal plate
7 Cutout
8 Glass sleeve
9 Contact pin
9a Head
10 Wire
11 Contact zone
12 Side edge
13 LED module
14 Cover
15 Basic body
16 Glass plate
17 Recess
18 Sealing ring
19 Supporting element
20 Bearing step
21 Adhesive
22 Base
23 Bearing area
24 Keyhole
25 Hole region
26 Web region
27 Contact circuit
28 Connection line
29 Screw hole
30 Housing
31 Integrated component
A Excerpt

1. A lighting apparatus, comprising:
comprising a light source substrate, to the front side of which at least one semiconductor light source, is fitted and the rear side of which is fitted to an electrically conductive carrier;
wherein alongside the light source substrate at least two electrically conductive contact pins are led through the carrier and the contact pins are electrically connected to the at least one semiconductor light source;
wherein the contact pins are in each case introduced into an electrically insulating sleeve and the respective sleeve is inserted into an associated cutout of the carrier.

2. The lighting apparatus as claimed in claim 1,
wherein the sleeves consist of glass.

3. The lighting apparatus as claimed in claim 1,
wherein the rear side of the light source substrate is connected to the carrier by means of a thermally conductive adhesive.

4. The lighting apparatus as claimed in claim 1,
wherein the contact ping are led through the carrier, each adjacent to a same side of the light source substrate.

5. The lighting apparatus as claimed in claim 1, further comprising:
an at least partly electrically conductive cover, which is seated on the carrier and curves over the sleeves and the light source substrate, and wherein the cover has a light-transmissive insert above the at least one semiconductor light source.

6. The lighting apparatus as claimed in claim 5,
wherein the light-transmissive insert is mounted on the cover by means of a bearing step.

7. The lighting apparatus as claimed in claim 5,
wherein the light-transmissive insert is fixed to the cover by means of an adhesive connection.

8. The lighting apparatus as claimed in claim 5,
wherein the cover has at least one of at least one lateral mounting recess and at least one lateral cutout.

9. The lighting apparatus as claimed in claim 5,
wherein the cover has a ring-shaped supporting element, which supports the cover on the light source substrate, wherein the supporting element surrounds the at least one semiconductor light source and runs laterally outside the light-transmissive insert.

10. The lighting apparatus as claimed in claim 1,
wherein the light source substrate is a ceramic substrate.

11. The lighting apparatus as claimed in claim 1,
wherein the sleeves are surrounded by a respective seal on a rear side of the carrier.

12. The lighting apparatus as claimed in claim 1,
wherein the carrier is present in the form of a plate.

13. The lighting apparatus as claimed in claim 1,
wherein the lighting apparatus is a luminous module.

14. The lighting apparatus as claimed in claim 1, further comprising:
at least one integrated component.

15. A method for producing a lighting apparatus,
the lighting apparatus comprising:
a light source substrate, to the front side of which at least one semiconductor light source, is fitted and the rear side of which is fitted to an electrically conductive carrier;
wherein alongside the light source substrate at least two electrically conductive contact pins are led through the carrier and the contact pins are electrically connected to the at least one semiconductor light source;
the method comprising:
introducing at least one contact pin into an electrically insulating sleeve; and
inserting the respective sleeve into an associated cutout of the carrier.

16. The method for producing a lighting apparatus as claimed in claim 15,
wherein the sleeve is fixed in the carrier by means of a thermal process.

17. The lighting apparatus as claimed in claim 1,
wherein the at least one semiconductor light source comprises at least one light-emitting diode.

18. The method for producing a lighting apparatus as claimed in claim 16,
wherein the sleeve is fixed in the carrier by means of a sintering process.
